(19) United States
(12) Patent Application Publication
(10) Pub. No.: US 2015/0046240 A1
(43) Pub. Date: Feb. 12, 2015

(54) SYSTEM AND METHOD FOR PROVIDING MOBILE COUPONS FOR REDEMPTION

(71) Applicant: Capital One Financial Corporation, McLean, VA (US)

(72) Inventor: Paul Young MORETON, Glen Allen, VA (US)

(21) Appl. No.: 14/455,008

(22) Filed: Aug. 8, 2014

Related U.S. Application Data
(60) Provisional application No. 61/863,495, filed on Aug. 8, 2013.

(51) Int. Cl. G06Q 30/02

(52) U.S. Cl. CPC G06Q 30/0215; G06Q 30/0222; G06Q 30/0225
USPC 705/14.17

(57) ABSTRACT

A system that uses a mobile device to efficiently redeem a coupon through a financial institution that includes a communication interface that receives, via a network, coupon data associated with one or more discounts and receipt data from a mobile device, a comparison processor that determines product data based on the receipt data and compares the coupon data with the receipt data, and a discount processor that provides a credit to an account holder based at least in part on the results of the comparison between the coupon data and the receipt data, wherein the credit is based on the coupon data.

### CROSS-REFERENCE TO RELATED APPLICATION

This application contains subject matter related to and claims the benefit of U.S. Provisional Patent Application No. 61/863,495, filed on Aug. 8, 2013, the entire contents of which is incorporated herein by reference.

### FIELD OF THE DISCLOSURE

The present disclosure relates to systems and methods of using a mobile device and associated digital wallet to more efficiently redeem coupons with a financial institution.

### BACKGROUND OF THE DISCLOSURE

Currently, shoppers at a store who wish to redeem coupons must present paper coupons at a physical point of sale location at the time of purchase. The merchant receives the coupons from the customer and applies the discount to the purchases. The merchant must then redeem the coupons with the product manufacturer or coupon provider to be reimbursed. The system is labor intensive and inefficient. Additionally, coupon providers, such as product manufacturers, have no way of knowing which customers are redeeming their coupons and how effective coupon campaigns are.

These and other drawbacks exist.

### SUMMARY OF THE DISCLOSURE

Various example embodiments provide systems and methods that use a mobile device to efficiently redeem a coupon through a financial institution that includes a communication interface that receives, via a network, coupon data associated with one or more discounts and receipt data from a mobile device, a comparison processor that determines product data based on the receipt data and compares the coupon data with the receipt data, and a discount processor that provides a credit to an account holder based at least in part on the results of the comparison between the coupon data and the receipt data, wherein the credit is based on the coupon data.

In an example embodiment, the system includes a database that stores the product data, the product data includes the credit for a particular product, wherein the comparison processor determines the product data by identifying the particular product based on the coupon data and the receipt data, and wherein the discount provider provides the credit for the particular product stored in the database.

In an example embodiment, the mobile device captures the coupon data by scanning a bar code on a paper coupon.

In various embodiments the receipt data includes one or more digital pictures of a paper receipt, wherein the one or more digital pictures were captured by a mobile device.

In various embodiments, the communication interface receives authorization information from an authorization network that includes an authorization time, the comparison processor determines a transaction time from the receipt data, and wherein the discount processor provides the credit to the account holder when the authorization time and the transaction time are substantially the same. Also, the communication interface receives authorization information from an authorization network that includes information that identifies a merchant, the comparison processor determines a merchant from the receipt data, and the discount processor provides the credit to the account holder when the merchant identified by the authorization information and merchant determined from the receipt are the same merchant.

The system further includes a statement processor that generate an account statement that includes the credit.

In an example embodiment, the receipt data includes information derived from optical character recognition on the mobile device. The receipt data also includes an image of a paper receipt captured by a mobile device, and wherein the system further comprises an optical character recognition module that recognizes receipt data from the image of the paper receipt.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for allowing an account holder to redeem coupons with a financial institution, according to an example embodiment of the disclosure;

FIG. 2 depicts a schematic diagram of a system for allowing an account holder to redeem coupons with a financial institution, according to an example embodiment of the disclosure;

FIG. 3 depicts a schematic diagram of a system for allowing an account holder to redeem coupons with a financial institution, according to an example embodiment of the disclosure;

FIG. 4 depicts a schematic diagram of a system for allowing an account holder to redeem coupons with a financial institution, according to an example embodiment of the disclosure; and

FIG. 5 depicts a schematic diagram of a method for allowing an account holder to redeem coupons with a financial institution, according to an example embodiment of the disclosure.

### DETAILED DESCRIPTION OF THE EMBODIMENTS

The following description is intended to convey a thorough understanding of the embodiments described by providing a number of specific example embodiments and details involving systems and methods of using a mobile device and associated digital wallet to provide direct coupon redemption to an account holder. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

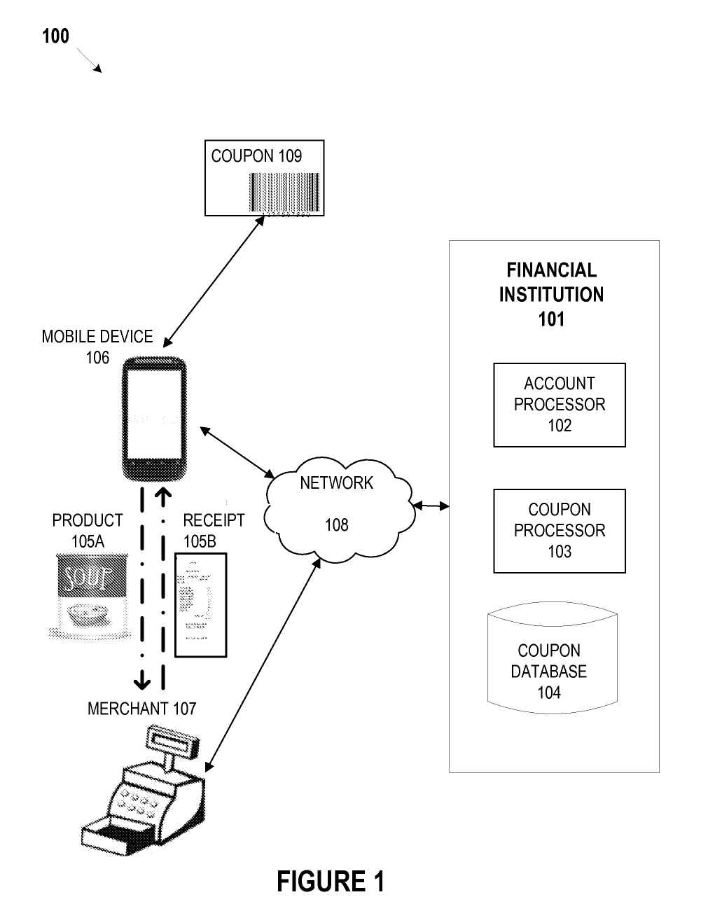

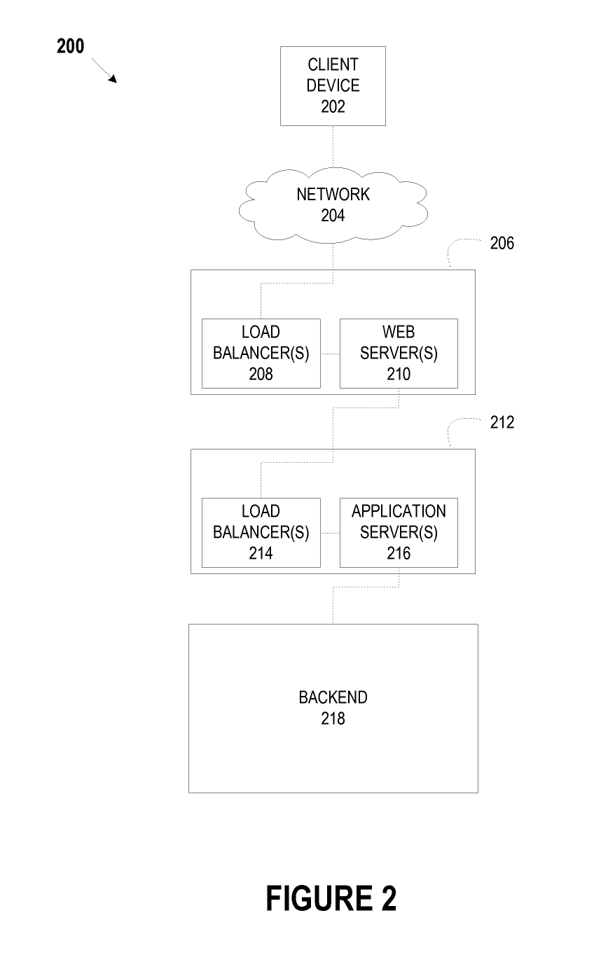

FIG. 1 depicts an example embodiment of a system for providing coupons (e.g., paper coupons and/or digital coupons) to an account holder's mobile device that may be directly redeemed with a financial institution, according to various embodiments of the disclosure. The system may include various network-enabled computer systems, including, as depicted in FIG. 1 for example, a financial institution system 101; comprising an account processor 102, a coupon processor 103, and a coupon database 104, which may be included as separate processors or combined into device having a single processor or device having the multiple processors. It is also noted that the system 100 illustrates only a single instance of each component. It will be appreciated that multiple instances of these components may be used. Moreover, the system 100 may include other devices not depicted in FIG. 1. For example, FIG. 2 depicts an example system 200 that may enable a financial institution, for example, to provide network services to its customers. As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 210 may distribute workloads across, for example, web server(S) 216 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 may include software that monitoring the port where external clients, such as, for example, client device 202, connect to access various services of a financial institution, for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 216 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributes system similar to system 200. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, a couponing platform that enables coupon redemption by a financial institution and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200.

Referring back to FIG. 1, in various example embodiments, the coupon processor 103, coupon database 104, and/or the account processor 102 may be separate from financial institution system 101. Coupon processor 103, coupon database 104, and/or account processor 102 also may be integrated into, for example, merchant 107. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to enable the creation and provisioning of one or more mobile account application's for mobile device 106.

The components depicted in FIG. 1 may store information in various electronic storage media, such as, for example, coupon database 104. Electronic information, files, and documents may be stored in various ways, including, for example, a flat file, indexed file, hierarchical database, relational database, such as a coupon database created and maintained with software from, for example, Oracle® Corporation, Microsoft® Excel file, Microsoft® Access file, or any other storage mechanism.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the example types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various example embodiments, an account holder may be any individual or entity that desires to conduct a financial transaction using one or more accounts held at one or more financial institutions. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, an account or service that links to an underlying payment account already described, or mobile commerce account. A financial institution may be, for example, a bank (e.g., a retail and/or commercial bank), other type of financial institution, including a debit and/or credit card provider, for example, or any other entity that offers accounts to customers. An account may or may not have an associated card, such as, for example, a credit card for a credit account or a debit card for a debit account. The account also may be associated with a digital wallet that, for example, operates on a mobile device of an account holder. The account may enable payment using biometric authentication, or contactless based forms of authentication, such as QR codes or near-field communications. The account card may be associated or affiliated with one or more social networking sites, such as a co-branded credit card.

Additionally, or alternatively, an account holder may access an account with financial institution system 101 using one or more software applications on mobile device 106. The software applications may provide one or more account services. The software application may be a mobile wallet application that stores coupon data from one or more coupons 109. The user of mobile device 106 in this disclosure need not have an account with a financial institution. The mobile wallet application may be provided by financial institution system 101, and/or merchant 107, and/or a third party. An account holder may have one or more shoppers accounts with merchants. The mobile wallet application described may be available to any user or individual with a mobile device, regardless of whether this individual has a financial account.

As used herein, mobile device 106 may be, for example, a handheld PC, a phone, a smartphone, a PDA, a tablet computer, wearable device (e.g., Google Glass) or other device. The mobile device may include Near Field Communication (NFC) capabilities, which may allow for communication with other devices by touching them together or bringing them into close proximity. Example NFC standards include ISO/IEC 18092:2004, which defines communication modes for Near Field Communication Interface and Protocol (NFCIP-1). For example, a mobile device may be configured using the Isis Mobile Wallet™ system, which is incorporated herein by reference. Other example NFC standards include those created by the NFC Forum.

As described in reference to FIG. 1, financial institution system 101 may provide an account holder with one or more financial accounts. The financial account may be associated with the account holder's one or more mobile devices, such as mobile device 106. The mobile device may be configured to act as a method of payment at a POS location (merchant 107) using, for example, NFC or any other mobile payment technology.

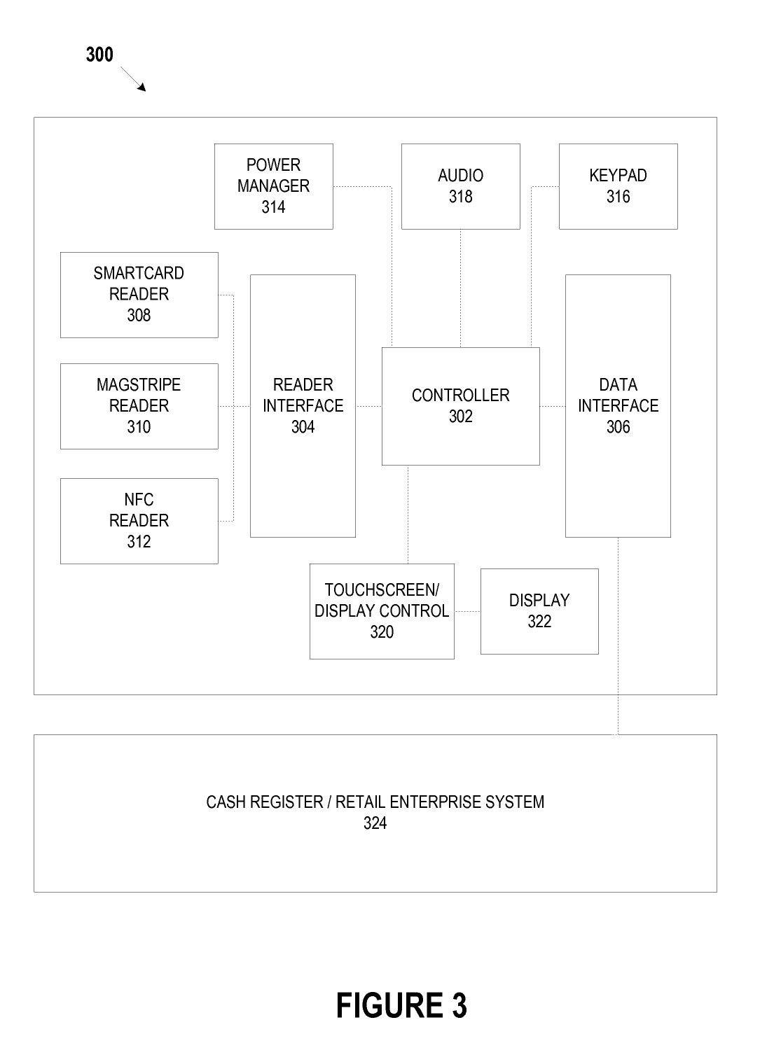

FIG. 3 depicts an example Point of Sale (PoS) device 300. PoS device 300 may provide the interface at what a customer or end user makes a payment to the merchant in exchange for goods or services. PoS device 300 may include and/or cooperate with weighing scales, scanners, electronic and manual cash registers, electronic funds transfer at point of sale (EFTPOS) terminals, touch screens and any other wide variety of hardware and software available for use with PoS device 300. PoS device 300 may be a retail point of sale system and may include a cash register and/or cash register-like computer components to enable purchase transactions. PoS device 300 also may be a hospitality point of sale system and include computerized systems incorporating registers, computers and peripheral equipment, usually on a computer network to be used in restaurant, hair salons, hotels or the like. PoS device 300 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 300 also may be a cloud-based point of sale system that can be deployed as software as a service, which can be accessed directly from the Internet using, for example, an Internet browser.

Referring to FIG. 3, an example PoS device 300 is shown. PoS device 300 may include a controller 302, a reader interface 304, a data interface 306, a smartcard reader 308, a magnetic stripe reader 310, a near-field communications (NFC) reader 312, a power manager 314, a keypad 316, an audio interface 318, a touchscreen/display controller 320, and a display 322. Also, PoS device 300 may be coupled with, integrated into or otherwise connected with a cash register/retail enterprise system 324.

In various embodiments, Controller 302 may be any controller or processor capable of controlling the operations of PoS device 300. For example, controller 302 may be a Intel® 2nd Generation Core™ i3 or i5 or Pentium™ G850 processor or the like. Controller 302 also may be a controller included in a personal computer, smartphone device, tablet PC or the like.

Reader interface 304 may provide an interface between the various reader devices associated with PoS device 300 and PoS device 300. For example, reader interface 304 may provide an interface between smartcard reader 308, magnetic stripe reader 310, NFC reader 312 and controller 302. In various embodiments, reader interface 304 may be a wired interface such as a USB, RS232 or RS485 interface and the like. Reader interface 304 also may be a wireless interface and implement technologies such as Bluetooth, the 802.11(x) wireless specifications and the like. Reader interface 304 may enable communication of information read by the various reader devices from the various reader devices to PoS device 300 to enable transactions. For example, reader interface 304 may enable communication of a credit or debit card number read by a reader device from that device to PoS device 300. In various embodiments, reader interface 304 may interface between PoS device 300 and other devices that do not necessarily “read” information but instead receive information from other devices.

Data interface 306 may allow PoS device 300 to pass communicate data throughout PoS device and with other devices including, for example, cash register/retail enterprise system 324. Data interface 306 may enable PoS device 300 to integrate with various customer resource management (CRM) and/or enterprise resource management (ERP) systems. Data interface 306 may include hardware, firmware and software that make aspects of data interface 306 a wired interface. Data interface 306 also may include hardware, firmware and software that make aspects of data interface 306 a wireless interface. In various embodiments, data interface 306 also enables communication between PoS device other devices.

Smartcard reader 308 may be any electronic data input device that reads data from a smart card. Smartcard reader 308 may be capable of supplying an integrated circuit on the smart card with electricity and communicating with the smart card via protocols, thereby enabling read and write functions. In various embodiments, smartcard reader 308 may enable reading from contact or contactless smart cards. Smartcard reader 308 also may communicate using standard protocols including ISO/IEC 7816, ISO/IEC 14443 and/or the like or proprietary protocols.

Magnetic stripe reader 310 may be any electronic data input device that reads data from a magnetic stripe on a credit or debit card, for example. In various embodiments, magnetic stripe reader 310 may include a magnetic reading head capable of reading information from a magnetic stripe. Magnetic stripe reader 310 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., ormat A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments.

NFC reader 312 may be any electronic data input device that reads data from a NFC device. In an exemplary embodiment, NFC reader 312 may enable Industry Standard NFC Payment Transmission. For example, the NFC reader 312 may communicate with a NFC enabled device to enable two loop antennas to form an air-core transformer when placed near one another by using magnetic induction. NFC reader 312 may operate at 13.56 MHz or any other acceptable frequency. Also, NFC reader 312 may enable a passive communication mode, where an initiator device provides a carrier field, permitting answers by the target device via modulation of existing fields. Additionally, NFC reader 312 also may enable an active communication mode by allowing alternate field generation by the initiator and target devices.

In various embodiments, NFC reader 312 may deactivate an RF field while awaiting data. NFC reader 312 may receive communications containing Miller-type coding with varying modulations, including 100% modulation. NFC reader 312 also may receive communications containing Manchester coding with varying modulations, including a modulation ratio of approximately 10%, for example. Additionally, NFC reader 312 may be capable of receiving and transmitting data at the same time, as well as checking for potential collisions when the transmitted signal and received signal frequencies differ.

NFC reader 312 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 312 may be able to utilize transmission protocols and methods that are developed in the future using other frequencies or modes of transmission. NFC reader 312 also may be backwards-compatible with existing payment techniques, such as, for example RFID. Also, NFC reader 312 may support transmission requirements to meet new and evolving payment standards including internet based transmission triggered by NFC. In various embodiments, NFC reader 312 may utilize MasterCard's® PayPass and/or Visa's® PayWave and/or American Express′® ExpressPay systems to enable transactions.

Although not shown and described, other input devices and/or readers, such as for example, barcode readers and the like are contemplated.

Power manager 314 may be any microcontroller or integrated circuit that governs power functions of PoS device 300. Power manager 314 may include, for example, firmware, software, memory, a CPU, a CPU, input/output functions, timers to measure intervals of time, as well as analog to digital converters to measure the voltages of the main battery or power source of PoS device 300. In various embodiments, Power manager 314 remain active even when PoS device 300 is completely shut down, unused, and/or powered by the backup battery. Power manager 314 may be responsible for coordinating many functions, including, for example, monitoring power connections and battery charges, charging batteries when necessary, controlling power to other integrated circuits within PoS device 300 and/or other peripherals and/or readers, shutting down unnecessary system components when they are left idle, controlling sleep and power functions (on and off), managing the interface for built-in keypad and trackpads, and/or regulating a real-time clock (RTC).

Keypad 316 may any input device that includes a set of buttons arranged, for example, in a block or pad and may bear digits, symbols and/or alphabetical letters. Keypad 316 may be a hardware-based or mechanical-type keypad and/or implemented in software and displayed on, for example, a screen or touch screen to form a keypad. Keypad 316 may receive input from a user that pushed or otherwise activates one or more buttons on keypad 316 to provide input.

Audio interface 318 may be any device capable of providing audio signals from PoS device 300. For example, audio interface may be a speaker or speakers that may produce audio signals. In various embodiments, audio interface 318 may be integrated within PoS device 300. Audio interface 318 also may include components that are external to PoS device 300.

Touchscreen/display control 320 may be any device or controller that controls an electronic visual display. Touchscreen/display control 320 may allow a user to interact with PoS device 300 through simple or multi-touch gestures by touching a screen or display (e.g., display 322). Touchscreen/display control 320 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 320 may receive inputs from the touchscreen and process the received inputs. Touchscreen/display control 320 also may control the display on PoS device 300, thereby providing the graphical user interface on a display to a user of PoS device 300.

Display 322 may be any display suitable for a PoS device. For example, display 322 may be a TFT, LCD, LED or other display. Display 322 also may be a touchscreen display that for example allows a user to interact with PoS device 300 through simple or multi-touch gestures by touching a screen or display (e.g., display 322). Display 322 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 322 may receive inputs from control gestures provided by a user. Display 322 also may display images, thereby providing the graphical user interface to a user of PoS device 300.

Cash register/retail enterprise system 324 may me any device or devices that cooperate with PoS device 300 to process transactions. Cash register/retail enterprise system 324 may be coupled with other components of PoS device 300 via, for example, a data interface (e.g., data interface 306) as illustrated in FIG. 3. Cash register/retail enterprise system 324 also may be integrated into PoS device 300.

In various embodiments, cash register/retail enterprise system 324 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 324 may comprise an retail enterprise system and/or a customer relationship management system. Retail enterprise system 324 may enable retain enterprises to manage operations and performance across a retail operation. Retail enterprise system 324 may be a stand-alone application in, for example, individual stores, or may be interconnected via a network. Retail enterprise system 324 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 324 also may include inventory control and tracking capabilities, reporting tools, customer management capabilities, employee management tools, and may integrate with other accounting software.

In various embodiments cash register/retail enterprise system 324 may be a hospitality PoS. In such embodiments, retail enterprise system 324 may include hospitality PoS software (e.g, Aloha PoS Restaurant software from NCR®, Micros® RES and Symphony software and the like), hospitality management software, and other hardware and software to facilitate hospitality operations.

Referring back to FIG. 1, when an account holder uses mobile device 106 at a POS location to perform a financial transaction, the financial transaction may be charged to the mobile payment account. For example, the account holder may use mobile device 106 in lieu of and/or in conjunction with a debit or a credit card to make a purchase merchant 107. The purchase would then be charged to the mobile payment account associated with the mobile device 106. The mobile payment account may be stored in a mobile payment account database at financial institution system 101. The account may be a traditional debit and/or credit card account where the account holder uses a credit card, rewards card, debit card, or similar method of payment to purchase goods and services from one or more merchants 107.

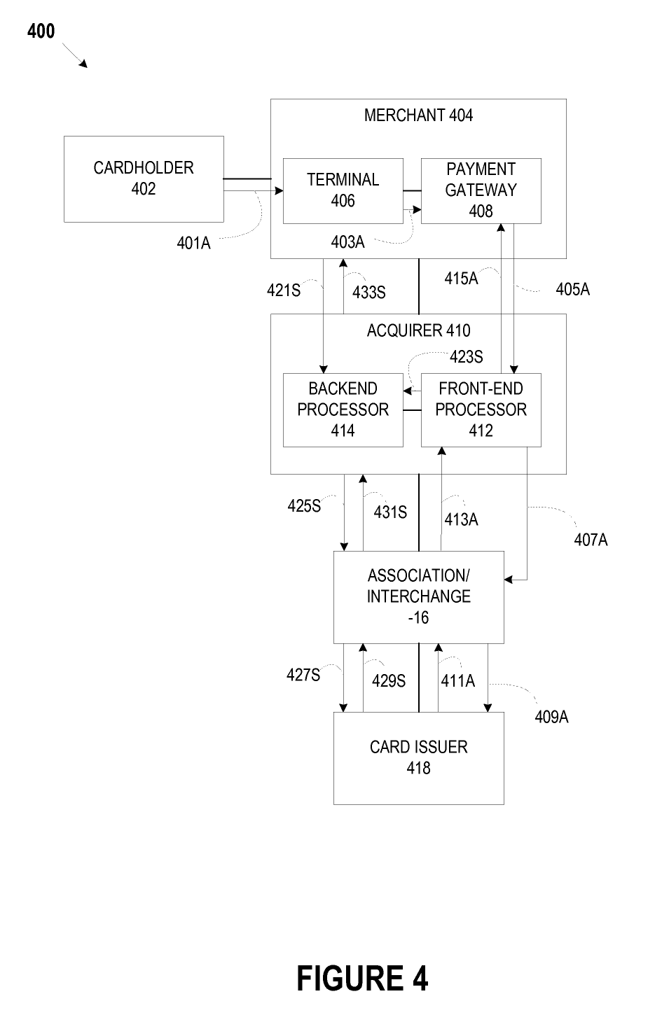

FIG. 4 illustrates an example system 400 and method for card authorization. As shown and described in FIG. 4, merchants, cardholders and financial institutions may be connected with a card association network to enable secure transactions and timely payments. System 400 may include a cardholder 402, merchant 404, Acquirer 410, Association/Interchange 416, and card issuer 418.

Cardholder 402 may be any card holder, including a credit card holder, debit card holder, stored value card holder and the like. Cardholder 402 may possess a plastic card or carry a device (e.g., a mobile device) that securely stores card credentials and is capable of transmitting the card credentials to, for example, a PoS terminal (e.g., terminal 406). Cardholder 402 may interact with a merchant (e.g., merchant 404) by presenting a card or card credentials to a terminal (e.g., terminal 406).

Merchant 404 may be any merchant that accepts payment from a cardholder, for example. Merchant 404 may be any retailer, service provider, business entity, or individual that accepts payments. Merchant 404 may include software, firmware and hardware for accepting and/or processing payments. For example, as illustrated in FIG. 4, merchant 404 may include a terminal 406 and a payment gateway 408. Terminal 406 and payment gateway 408 may comprise the physical or virtual device(s) used by merchant 404 to communicate information to front-end processor 412 of acquirer 410. Terminal 406 may be similar to PoS system [Y00] as shown and described in Figure Y. In various embodiments, payment gateway 408 may be an e-commerce application service provider service that authorizes payments for merchants. As such, payment gateway 408 may be a virtual equivalent of a PoS terminal and interface with, for example, a billing system of merchant 404 and pass data to front-end processor 412 of acquirer 410.

Acquirer 410 may be, for example, a financial institution or bank, that holds the contract for providing payment processing services to merchant 404. Merchant 404 may have a merchant account that may serve as a contract under which Acquirer 410 may extend a line of credit to a merchant who wishes to accept, for example, credit card transactions. As shown in FIG. 4, Acquirer 410 may be associated with front-end processor 412 and back-end processor 414.

In various examples, front-end processor 412 may be a platform that card terminal 406 and/or payment gateway 408 communicate with when approving a transaction. Front-end processor 412 may include hardware, firmware, and software to process transactions. Front-end processor 412 may be responsible for the authorization and capture portion of credit card transaction. Front-end processor 412 also may include additional front-end platform interconnections to support, for example, ACH and debit transactions.

Backend processor 414 may be a platform that takes captured transactions from front-end processor 412 and settles them through an Interchange system (e.g., association/interchange 416). Back-end processor 414 may generate, for example, daily ACH files for merchant settlement. Back-end processor 414 also may handle chargeback handling, retrieval request and monthly statements.

Association/interchange 416 may be the consumer payment system whose members are the financial institutions that issue payment cards and/or sign merchant to accept payment cards. Example associations/interchanges 416 may include, Visa®, MasterCard®, and AmericanExpress®. Association/interchange 416 may include one or more computer systems and networks to process transactions.

Issuer 418 may be a financial institution that issues payment cards and maintains a contract with cardholders for repayment. In various embodiments, issuer 418 may issue credit, debit, and/or stored value cards, for example. Example issuers may include, Capital One, Bank of America, Citibank, and the like.

In various embodiments, processing a payment card transaction may involves two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, cardholder 402 may present payment card as payment (401A) at merchant 404 PoS terminal 406, for example. Merchant 404 may enter card into a physical PoS terminal 406 or submit a credit card transaction to a payment gateway 408 on behalf of cardholder 402 via secure connection from a Web site, retail location, or a wireless device.

Payment gateway 408 may receive the secure transaction information (403A) and may pass the secure transaction information (405A) via a secure connection to the merchant acquirer's 410 front-end processor 412.

Front-end processor 412 may submit the transaction (407A) to association/interchange 416 (e.g., a network of financial entities that communicate to manage the processing, clearing and settlement of credit card transactions). Association/interchange 416 may route the transaction (409A) to the customer's Issuer 418. Issuer 418 may approve or decline the transaction and passes the transaction results back (411A) through association/interchange 416. Association/interchange then may relay the transaction results (413A) to front-end processor 412.

Front-end processor 412 may relay the transaction results (415A) back to the payment gateway 408 and/or terminal 406. Payment gateway 408 may store the transaction results and sends them to merchant 404. Merchant 404 may receive the authorization response and complete the transaction accordingly.

During settlement, merchant 404 may deposit the transaction receipt (421S) with acquirer 410 via, for example, a settlement batch. Captured authorizations may be passed (423S) from front-end processor 412 to the back-end processor 414 for settlement. Back-end processor may generates ACH files for merchant settlement. Acquirer may submit settlement files (425S, 427S) to Issuer 418 for reimbursement via association/interchange 416. Issuer 418 may post the transaction and pay merchant 404 (429S, 431S, 433S).

Referring back to FIG. 1, an account holder may use his or her mobile device 106 to capture coupon data from one or more coupons 109. Coupon 109 may be a paper coupon and/or a digital coupon. The coupon may offer a discount on one or more products, such as product 105a. The coupon may be provided by the manufacturer of product 105a. The coupon may be provided by financial institution system 101. The coupon also may be provided by a manufacturer of product 105a. The coupon may be provided by merchant 107. For example, the coupon may be provided by Pepsi Cola, and offer a buy-one-get-one-free deal on 2-liter bottles of Diet Pepsi. The paper coupon may be provided in a newspaper, magazine, or catalogue.

The coupon may include stock-keeping-unit (SKU) data, Universal Product Code (UPC) barcode data, QR codes, or other data that can be read using Radio Frequency Identification (RFID) technology. Mobile device 106 may be equipped with one or more barcode scanners, cameras, RFID readers and the like. Account holder may scan or capture the coupon data from coupon 109 and the coupon data may be stored on the mobile device 106 using the mobile wallet application.

In various embodiments, coupon 109 may be electronically provided to mobile device 106. Account holder may download the coupon data from a website, or receive it as an electronic message, push notification, iBeacon transmission and/or email. The coupon may be electronically provided to mobile device 106 from one or more product manufacturers (not shown), or from financial institution system 101, or merchant 107. Account holder may store the coupon data on mobile device 106 using, for example, a mobile wallet application.

The coupon data may identify the product or products being offered at a discounted price. The coupon data may identify the number of products that the coupon may be applied to. The coupon data may include an expiration date and time for the offer. The coupon data may include the amount of the discount. The coupon data may identify the manufacturer of the product or products. The coupon data may identify specific merchants where the coupon may be used, such as merchant 107.

As shown in FIG. 1, an account holder may purchase one or more products, such as product 105a, at merchant 107. In an example embodiment, merchant 107 may be a grocery store, and may sell one or more food products such as product 105a. These food products may be perishable and/or imperishable goods, for example. In various embodiments, merchant 107 may be any other type of store that sells goods or services (such as a hardware store, clothing goods store, furniture store, home appliances store, electronics store, games, music, multimedia, etc.). Product 105a may be a physical good or service offered for sale by merchant 107.

The product may include product identification data. Product identification data may include stock-keeping-unit (SKU) data. Product identification data may include Universal Product Code (UPC) barcode data. Product identification data may include data that can be read using Radio Frequency Identification (RFID) technology. The mobile user's mobile device 106 may be equipped with one or more barcode scanners, cameras, RFID readers and/or the like. Account holder may upload or otherwise receive the product identification data onto his mobile device 106 by “scanning” and/or “imaging” the product's bar code using a barcode reader or technology incorporated into a camera on mobile device 106 that acts as a barcode scanner. The mobile device also may be equipped with one or more cameras that can take a picture of a product's bar code.

Merchant 107 may also scan product 105a when the account holder purchases it. At the conclusion of the purchase, merchant 107 may print out a receipt 105b for account holder. The receipt 105b may include a print-out of all the items or products that were purchased, the amount of each, the purchase price for each product, the date and time of the purchase, the name and location of merchant 107, and other relevant information. Receipt 105b may be physically printed and given to the account holder via, for example, email or other ways of providing, transmitting, and/or storing the receipt within a mobile application. Receipt 105b may be electronically provided to the account holder. The account holder may pay for the products using a payment method associated with his account at financial institution system 101 (such as a credit card or debit card).

The account holder may capture the product data from receipt 105b using mobile device 106. The account holder may use the mobile wallet application to capture the product data from the receipt by taking a picture of the receipt using a camera on mobile device 106. The account holder may scan the receipt using mobile device 106. Mobile wallet application may use (e.g., in conjunction with software in mobile device 106) optical character recognition (OCR) or other image scraping technology to derive product data from the captured digital image or images. The OCR technology may derive product data from one or more keywords on the receipt. The product data may be the name of the purchased product or products. Product data may be the product name, quantity, price, weight, product manufacturer, brand name, merchant identification, date and time of purchase, and other information related to product 105a.

As previously stated, product data also may be captured if the mobile device directly scans SKU data, UPC data, RFID data, QR codes, or other information physically located on the product 105a. Product data may be stored on mobile device by the account holder using the mobile wallet application. Where, for example, a receipt also is obtained in the mobile wallet application, the captured product data may be analyzed along with the product data from the receipt to optimize the product data associated with the receipt.

Account holder may provide the captured product data and the coupon data to coupon processor 103 at financial institution system 101 via, for example, network 108. Mobile wallet application may provide one or more graphical user interfaces to enable the user to interact with one or more websites or mobile websites provided by financial institution system 101. The account holder may use the mobile wallet application to upload the product data and coupon data to coupon processor 103. Also, mobile wallet application may provide the captured receipt images to coupon processor 103, and coupon processor 103 may perform the OCR or image scraping step to derive the product data from the digital images of the one or more receipts (such as receipt 105b).

Coupon processor 103 may use the received coupon data to retrieve discount data from coupon database 104. Coupon database 104 may comprise discount data provided by the manufacturer of product 105a. The discount data may be provided by financial institution system 101. The discount data may be provided by advertisers, and/or merchant 107. The discount data may identify the product or products being offered at a discounted price. The discount data may include the amount of the discount. The discount data may identify the number of products that the coupon may be applied to. The discount data may include an expiration date and time for the offer. The discount data may include the product brand name. The discount data may include a geographical location where the coupon is valid or invalid. The discount data may identify the manufacturer of the product or products. The discount data may identify specific merchants where the coupon may be used, such as merchant 107.

The discount data in the coupon database 104 may have been previously associated with coupon data (such as the data found in the bar code on the coupon 109). Coupon processor 103 may match the received coupon data with the stored discount data in coupon database 104 and retrieve the discount data. Coupon processor 103 may then compare the product data with the discount data. If the discount data matches a portion of the product data from the one or more receipts, the coupon processor 103 may signal account processor 102 to apply the appropriate discount (e.g., a credit) to the account holder's payment account.

For example, if an account holder used an iPhone to capture coupon data from a coupon for buy-one-get-one-free on 2 Liter bottles of Diet Pepsi. The account holder then purchases two 2 liter bottles of Diet Pepsi at a grocery store for $2.50 each, and is given a receipt. The receipt includes the name of the product purchased (2 L Diet Pepsi), the amount (2), and the unit price ($2.50/bottle). The account holder then takes a picture of the receipt, and uploads the picture and the coupon data to coupon processor 103 using the mobile wallet application on the user's iPhone. Coupon processor 103 may use one or more OCR processes to derive product data from the digital images of the receipt. Coupon processor 103 may determine that the account holder purchased two 2 liter bottles of Diet Pepsi, for $2.50 each.

In one embodiment, coupon processor 103 may confirm the accuracy of the derived product data by sending one or more electronic notifications to the account holder, where the one or more notifications include the product data. The notifications may be one or more of a text message, email, SMS, or other form of electronic communication providing the account holder with the derived product data and requesting the account holder to confirm the accuracy. If the account holder responds and confirms the accuracy of the derived product data, then coupon processor 103 may proceed as described further. If the account holder responds and indicates that the product data is inaccurate, coupon processor 103 may re-run the OCR processes on the digital images of the receipt and/or request accurate product data from the account holder.

Coupon processor may use the coupon data to retrieve the discount data from coupon database 104. The discount data may include information identifying the product offered at a discount (2 liter bottles of Diet Pepsi), the amount or nature of the discount (buy one get one free), and information about the coupon provider (PepsiCola). The discount data may have been previously provided to the financial institution system 101 by the manufacturer (PepsiCola), an advertiser, a merchant, or some other third-party entity.

The coupon processor 103 may then compare this product data to the discount data to find one or more matches. Coupon processor 103 may determine that the product brand matches (Pepsi). Coupon processor 103 may determine that the product name matches (2 Liter bottles of Diet Pepsi). The coupon processor 103 may determine the quantity matches (two 2 Liter bottles of Diet Pepsi make the purchase eligible for the discount). The coupon processor 103 may, for example, compare the expiration date of the discount data with the date and time the product was purchase (derived from the product data) to ensure the coupon has not expired.

Based on the one or more comparison matches, coupon processor 103 may then signal or otherwise instruct account processor 102 to credit the account holder's payment account for $2.50, the value of the discount from the coupon. Financial institution system 101 may also handle the redemption of the coupon with the coupon provider (such PepsiCola in this example).

Coupon processor 103 and/or mobile wallet application may be configured to analyze the product data and/or the receipt image to determine if one or more coupons were already used in the purchase. Coupon processor 103 may compare the discount data with the product data to determine if one or more coupons have already been used. If so, the coupon processor 103 may stop the process and prevent the account processor 102 from applying the discount to the account holder's account. In this way, the coupon processor 103 may prevent an account holder from using the same coupon multiple times (e.g., once during the physical purchase of the product at merchant 107, and a second time after submitting the coupon data to coupon processor 103).

Coupon processor 103 may perform other validity checks. For example, the coupon processor 103 may determine the date and time of the transaction, as well as the merchant name and/or location, from the product data derived from receipt 105b. Account processor 102 may retrieve payment information from the relevant payment account. The payment information may have been previously submitted by the merchant 107 based on the method of payment that the account holder used to purchase the one or more products 105a. The payment information may include the account number of the method of payment, a date and time of the transaction, the merchant name, the location, and other information identifying the transaction. Coupon processor 103 may compare the payment information with the product data derived from the receipt 105b. If one or more of the date, time, merchant name, merchant location, or other information matches, then the coupon processor 103 may continue with the process. If the comparison does not return a match, the coupon processor 103 may signal or otherwise instruct the account processor 102 to not apply the discount data to the account holder's payment account.

Financial institution system 101 may compile purchase data for the account holder based on the product data derived from the receipt 105b. Purchase data may include the products or items that the account holder purchased, the amount of each purchase, whether the account holder used a coupon, the location of the purchases, and other relevant information. Financial institution system 101 may compile coupon trend data for each coupon stored in coupon database 104. Coupon trend data may include the amount of times a coupon or promotion was redeemed by account holders, the products that were purchased, the geographic region or regions where the coupons were redeemed, the merchants where the products were purchased, and other relevant information. Financial institution system 101 may provide the coupon trend data and or purchase data to one or more advertisers, merchants, manufacturers, and other third parties. The coupon trend data and purchase data may be used to more efficiently target promotions, advertisements, deals, coupons, and other rewards to account holders and other potential customers.

In various embodiments, the account holder may capture the coupon data on his mobile device 106 after purchasing a product with merchant 107. In one example, an account holder may have bought five bags of Frito Lays chips at the grocery store on Monday at full price and paid for them using a credit card from financial institution system 101. On Wednesday, for example, the account holder may find several coupons in the newspaper offering buy four bags of Frito Lay chips and get the fifth bag free. The account holder may capture the coupon data using the process described above and submit it, along with the receipt and/or product data from the Monday purchase, to coupon processor 103/financial institution system 101 for processing, as described above. If the account holder had previously submitted the product data and/or receipt from the Monday purchase, the coupon processor 103 may retrieve this information and use it for the comparison described above. In this way, a customer may redeem coupons acquired after a product has already been purchased.

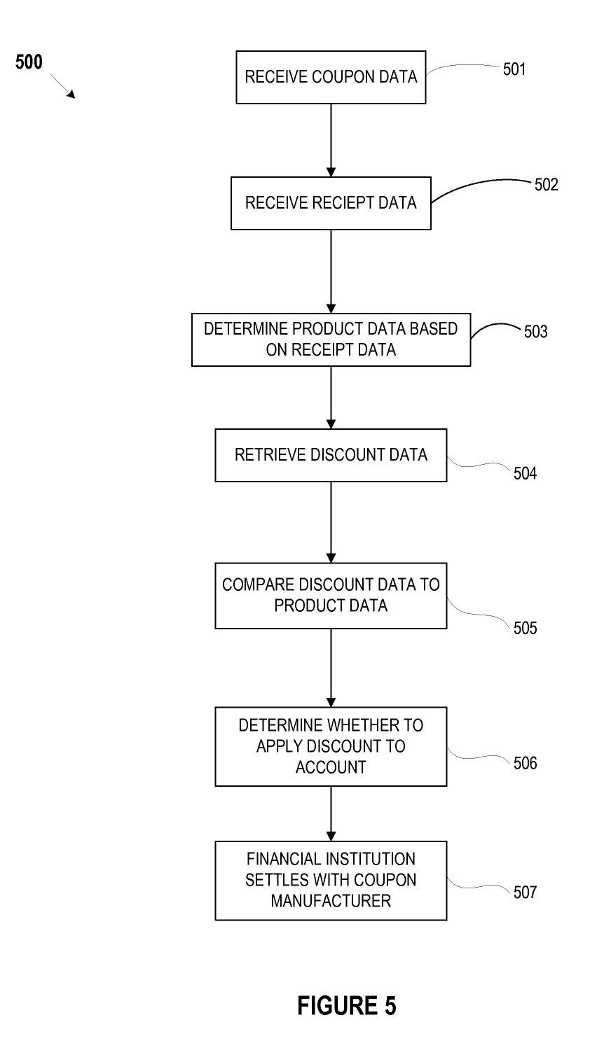

FIG. 5 is a flow chart illustrating a method using a mobile device and associated mobile wallet application to efficiently redeem coupons with a financial institution. The method 500 shown in FIG. 5 can be executed or otherwise performed by one or more combinations of various systems. The method 500 as described below may be carried out by the system for redeeming coupons with a financial institution as shown in FIGS. 1-4, by way of example, and various elements of that system are referenced in explaining the method of FIG. 5. Each block shown in FIG. 5 represents one or more processes, methods, or subroutines in the example method 500. Referring to FIG. 5, the example method 500 may begin at block 501.

In block 501, coupon data may be received. In one example, a paper coupon may offer 50% off 14 oz. cans of Campbell's tomato soup. The coupon may have been created by a merchant, advertiser, or the product manufacturer. An account holder A may scan the bar code of the paper coupon using one or more RFID reading devices on his mobile device. The coupon may have been electronically provided to the account holder A's mobile device. Account holder A may store the coupon data identifying the coupon on his mobile device using a mobile wallet application.

The coupon data may identify the product or products being offered at a discounted price. The coupon data may identify the number of products that the coupon may be applied to. The coupon data may include an expiration date and time for the offer. The coupon data may include the amount of the discount. The coupon data may identify the manufacturer of the product or products. The coupon data may identify specific merchants where the coupon may be used, such as merchant 107. In this example, the coupon data would identify the brand name of the product (Campbell's), the product name (tomato soup), the unit weight or volume (14 oz.), the type of discount (50% off a purchase), and other information. Mobile device 106 may provide the coupon data to a financial institution system. Method 500 may proceed to block 502.

At block 502, receipt data may be received. The receipt may have been obtained by account holder A after he made a purchase at the grocery store. In this example, account holder A purchased five cans of Campbell's tomato soup, for $1.50 per can, for a total cost of $7.50. Account holder may have used a credit card associated with financial institution system to make the purchase. The grocery store may have printed out a receipt for the account holder that includes the items purchased, the cost per item, the total amount paid, the location of the purchase, a date and time of purchase, the merchant, the item name and/or brand, and other information.

Account holder A may capture one or more digital images of the receipt using, for example, one or more cameras on his mobile device. The digital images may include the receipt data. Account holder A may then provide the receipt data to a financial institution system, along with the coupon data. In this embodiment, blocks 501 and 502 may occur simultaneously, e.g., as the mobile device transmits the coupon data and the receipt images and/or receipt data to the financial institution system for processing by coupon processor 103. Method 500 may continue at block 503.

In block 503, product data may be determined based on the receipt data. In various embodiments, coupon processor may determine the product data. Also, the mobile device itself may alone, or in conjunction with a coupon processor, determine the product data. Coupon processor 103 and/or the mobile device may use OCR or other image scraping technology to derive product data from the receipt data. The OCR technology may derive product data from one or more keywords on the receipt. The product data may be the name of the purchased product or products. Product data may be the product name, quantity, price, weight, product manufacturer, brand name, merchant identification, date and time of purchase, and other information related to the purchased items shown on the receipt. Continuing with the previous example, the receipt image may show that the account holder purchased five cans of Campbell's tomato soup, at $1.50/can, at a certain grocery store on a certain date. The coupon processor and/or mobile device may use OCR to capture these and other keywords from the receipt image received from the account holder's mobile device.

As previously stated, product data may also be captured by the mobile device directly scanning SKU data, UPC data, RFID data, QR codes, or other information physically located on the product. The product data may be provided to the coupon processor 103 in this form. Method 500 may proceed to block 504.

At block 504, discount data may be retrieved from one or more databases using the coupon data. Coupon processor 103 may use the coupon data to retrieve the discount data from coupon database 104. The discount data may include information identifying the product offered at a discount (14 oz. cans of tomato soup), the amount or nature of the discount (50% off), and information about the coupon provider (Campbell). The discount data may have been previously provided to the financial institution system by the manufacturer (Campbell), an advertiser, a merchant, or some other third-party entity. Method 500 may proceed to block 505.

At block 505, method 500 may compare the discount data to the product data to determine if there are one or more matches. Coupon processor 103 may determine that the product brand matches the brand name from the discount data (Campbell). Coupon processor 103 may determine that the product name matches the name from the discount data (14 oz. cans of tomato soup). The coupon processor 103 may compare the expiration date of the discount data with the date and time the product was purchase (derived from the product data) to ensure the coupon has not expired. The coupon processor 103 may determine how close the match is, based on the number of keywords in the product data that match with the discount data. For example, the coupon may use a matching score or like certainty score and determine that there is a match when the score is above a certain threshold (e.g., 90%). Method 500 may proceed to block 506.

At block 506, method 500 a determination is made whether to apply a discount to the account holder's payment account. In various embodiments the financial institution may make this determination. The determination may be based on, for example, the results of the comparison step performed at block 505. If a predetermined number or percentage of the product data keywords match the discount data, coupon processor 103 may signal or otherwise instruct account processor 102 to credit the account holder's payment account in the amount of the discount. The determination also may be based on comparing an authorization time stamp associated with the transaction (as described in, for example, FIG. 4) and merchant on the receipt. If, for example, the authorization stamp and the receipt time are within a threshold amount (e.g., two minutes) and/or the merchant names and/or identifiers match, the discount may be applied. In the example shown above, the discount would be 50% off the total amount spent on soup ($7.50), meaning account processor would credit account holder A's credit card account for $3.25. Account processor may create one or more statements showing this credit. Financial institution system may also handle the redemption of the coupon with the coupon provider (Campbell) in block 207 so that financial institution system may be reimbursed for the value of the discount.

It is further noted that the software described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A system comprising:
a communication interface of a financial institution that receives, via a network, coupon data associated with one or more discounts and receipt data from a mobile device;
a comparison processor of a financial institution that determines product data based on the receipt data and compares the coupon data with the receipt data; and
a discount processor of a financial institution that provides a credit to an account holder based at least in part on the results of the comparison between the coupon data and the receipt data, wherein the credit is based on the coupon data.

2. The system of claim 1, further comprising a database that stores the product data, the product data including the credit for a particular product, wherein the comparison processor determines the product data by identifying the particular product based on the coupon data and the receipt data, and wherein the discount provider provides the credit for the particular product stored in the database.

3. The system of claim 1, wherein the mobile device captured the coupon data by scanning a bar code on a paper coupon.

4. The system of claim 1, wherein the receipt data comprises one or more digital pictures of a paper receipt, wherein the one or more digital pictures were captured by a mobile device.

5. The system of claim 1, wherein the communication interface receives authorization information from an authorization network that includes an authorization time, the comparison processor determines a transaction time from the receipt data, and wherein the discount processor provides the credit to the account holder when the authorization time and the transaction time are substantially the same.

6. The system of claim 1, wherein the communication interface receives authorization information from an authorization network that includes information that identifies a merchant, the comparison processor determines a merchant from the receipt data, and wherein the discount processor provides the credit to the account holder when the merchant identified by the authorization information and merchant determined from the receipt are the same merchant.

7. The system of claim 5, wherein the authorization information includes information that identifies a merchant, the comparison processor determines a merchant from the receipt data, and wherein the discount processor provides the credit to the account holder when the merchant identified by the authorization information and merchant determined from the receipt are the same merchant.

8. The system of claim 1, further comprising a statement processor that generate an account statement that includes the credit.

9. The system of claim 1, wherein the receipt data includes information derived from optical character recognition on the mobile device.

10. The system of claim 1, wherein the receipt data includes an image of a paper receipt captured by a mobile device, and wherein the system further comprises an optical character recognition module that recognizes receipt data from the image of the paper receipt.
